(19) United States
(12) Patent Application Publication
(10) Pub. No.: US 2025/0046062 A1
(43) Pub. Date: Feb. 6, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: TAKAHISA YAMAMOTO, Kanagawa (JP); SHUNTA TATE, Tokyo (JP); TOMOAKI KAWAI, Kanagawa (JP)

(21) Appl. No.: 18/793,309

(22) Filed: Aug. 2, 2024

(30) Foreign Application Priority Data
Aug. 4, 2023 (JP) 2023-127815

(51) Int. Cl. G06V 10/771; G06V 10/74; G06V 10/77; G06V 10/98

(52) U.S. Cl. CPC G06V 10/771; G06V 10/761; G06V 10/7715; G06V 10/993

(57) ABSTRACT

An information processing apparatus includes one or more memories storing instructions, and one or more processors that, upon execution of the stored instructions, are configured to extract feature information from an input image, in a case where it is determined that the extracted feature information is inappropriate for object recognition, accumulate the feature information, and based on feature information extracted from an image as a processing target and the accumulated feature information, determine whether the image as the processing target is an inappropriate image for object recognition.

### BACKGROUND

### Field of the Disclosure

The present disclosure relates to an information processing apparatus, an information processing method, and a storage medium.

### Description of the Related Art

In recent years, many techniques for processing an image to a high degree and extracting useful information have been discussed. Among these techniques, an object recognition technique for identifying to which of classes registered in advance an object present in an image belongs using a multi-layer neural network termed a deep network is being actively researched and developed.

The progress of the object recognition technique using a deep network is remarkable. However, there is also a case where an object recognition process does not reach the degree of perfection at which an object can always be correctly identified. Depending on the condition under which an input image is captured, an object can be incorrectly identified as a class different from its correct answer. Thus, a technique is under consideration for improving the identification accuracy by filtering (selecting) images to be input and setting only an image appropriate to be identified as an identification target.

Japanese Patent Application Laid-Open No. 2013-73439 discusses a technique for preparing a degradation determination dictionary for determining a degraded image, and based on the degree of degradation of an image calculated using the degradation determination dictionary, determining whether to reject the result of recognition. In the technique discussed in the publication of Japanese Patent Application Laid-Open No. 2013-73439, however, it is necessary to prepare the degradation determination dictionary, and it is also necessary to train the degradation determination dictionary. Japanese Patent Application Laid-Open No. 2019-67194 also discusses a technique for scrutinizing a keyword for use in an image search to collect a high-quality learning image by an image search. Japanese Patent Application Laid-Open No. 2019-67194, however, does not mention an improvement in the quality of an image collected once.

### SUMMARY

Embodiments of the present disclosure are directed to enabling the identifying of an image inappropriate for use in an object recognition process.

According to an aspect of the present disclosure, an information processing apparatus includes one or more memories storing instructions, and one or more processors that, upon execution of the stored instructions, are configured to extract feature information from an input image, in a case where it is determined that the extracted feature information is inappropriate for object recognition, accumulate the feature information, and based on feature information extracted from an image as a processing target and the accumulated feature information, determine whether the image as the processing target is an inappropriate image for object recognition.

Further features of various embodiments will become apparent from the following description of exemplary embodiments with reference to the attached drawings.

### BRIEF DESCRIPTION OF THE DRAWINGS

FIG. 1 is a diagram illustrating an example of the configuration of an information processing apparatus according to a first exemplary embodiment.

FIG. 2 is a flowchart illustrating an example of processing of the information processing apparatus according to the first exemplary embodiment.

FIG. 3 is a diagram illustrating an example of the configuration of an information processing apparatus according to a second exemplary embodiment.

FIG. 4 is a flowchart illustrating an example of processing of the information processing apparatus according to the second exemplary embodiment.

FIG. 5 is a diagram illustrating an example of the configuration of an information processing apparatus according to a third exemplary embodiment.

FIG. 6 is a flowchart illustrating an example of processing of the information processing apparatus according to the third exemplary embodiment.

FIG. 7 is a diagram illustrating an example of a configuration regarding a learning process.

FIG. 8 is a diagram illustrating processing of a feature vector extraction unit.

FIG. 9 is a diagram illustrating processing of a class classification unit.

FIG. 10 is a flowchart illustrating an example of processing in learning.

FIG. 11 is a diagram illustrating an example of the configuration of an information processing apparatus according to a fourth exemplary embodiment.

FIG. 12 is a flowchart illustrating an example of processing of the information processing apparatus according to the fourth exemplary embodiment.

FIG. 13 is a diagram illustrating an example of a hardware configuration of an information processing apparatus.

### DESCRIPTION OF THE EMBODIMENTS

Exemplary embodiments of the present disclosure will be described based on the drawings.

The present exemplary embodiments relate to an object recognition technique for identifying to which of classes registered in advance an object present in an input image belongs. The following is a description using as an example a case where the object recognition technique according to the present exemplary embodiments is applied to a face authentication (individual authentication) system that identifies to which of people registered in advance the face of a person present in an input image belongs on the assumption that the face of a person is a target object. In face authentication, for example, using a multi-layer neural network termed a deep network, an input face image and face images of a plurality of people registered in advance are compared with each other, and it is determined who the person in the input face image is. A deep network is also referred to as a “deep neural network” or “deep learning”. Although an example is described where the object recognition technique according to the present exemplary embodiments is applied to a face authentication system, a target object in object recognition is not limited to faces, and the exemplary embodiments described below are also applicable to another target object.

In a first exemplary embodiment, a description will be given using as an example a case where an information processing apparatus according to the present exemplary embodiment is applied to a system that performs face authentication. In the present exemplary embodiment, for example, face authentication is performed through the use of a feature extractor that extracts information (a feature vector) distinguishing a person from a face image using a neural network for which feature extraction parameters are set. With a high similarity score obtained by comparing two feature vectors obtained from two images, it is determined that the people having the faces appearing in the two images are a person. With a low similarity score, it is determined that the people having the faces appearing in the two images are different people.

First, an incorrect identification induction image and a method for collecting incorrect identification induction images will be described.

With an object recognizer obtained by learning that recognizes a target object in an image, it is necessary to evaluate the evaluation of the object recognizer to find out the accuracy of the object recognizer. The “evaluation” refers to the work of inputting an image (an evaluation image) to the object recognizer and examining whether the object recognizer can correctly recognize its target object (whether the result of the recognition is correct). When the object recognizer is evaluated, various types of images are generally input to the object recognizer, examining whether the characteristics of the object recognizer are biased, i.e., whether there are some images at which the object recognizer are remarkably good or other images at which the object recognizer is remarkably poor.

In the following description, an evaluation image that causes the object recognizer to produce an inappropriate recognition result in the process of such evaluation work is also referred to as an “incorrect identification induction image”. The term “incorrect identification induction” is used in the sense that incorrect identification is induced as a result of the object recognizer failing to appropriately extract feature information regarding the target object from an evaluation image.

For example, a wide variety of face images is input to a feature extractor regarding a face image used as the object recognizer for the evaluation of the feature extractor. Then, two feature vectors obtained from two images are compared with each other, and it is determined whether the people having the faces appearing in the two images are a person or different people (other people).

Suppose that in this evaluation work, the feature extractor to which two very blurred face images of different people (other people) are input extracts similar feature vectors regarding the two face images, resulting in a high similarity score. Feature vectors could not have been extracted from such blurred images that the contours of the faces or the positions of the parts are unclear. Moreover, if both two face images are similar blurred images, the feature extractor may extract similar feature vectors. However, since the face images of the different people are input, it should be determined that the people in the two images are different people, not the same person, as a result of face authentication. Thus, such images can be said to be incorrect identification induction images. That is, a very blurred image can be said to be an image that makes it difficult for the feature extractor regarding a face image to extract information identifying an individual from the image.

In the above examples of the blurred images, a description has been given of an example of a case where face images of different people (other people) are input. However, even if face images of a person (the person themselves) are input, which are very blurred images, it is considered appropriate to determine that the people in the face images are different people (other people), not the same person. This is because if the face images are such blurred images that even a human eye cannot determine whether the people in the face images are the same person, it is considered impossible to appropriately extract information (feature vectors) distinguishing an individual from the images. If information that allows the distinction of an individual cannot be appropriately extracted, it is dangerous to determine that the people in the face images are the same person based on the information, and it is more natural to determine that the people in the face images are different people. Also, in consideration of applications using a face authentication system (e.g., control of entry to and exit from a room), it is safer to determine that the people in such blurred images that information that allows the distinction of an individual cannot be extracted from the images are different people (other people).

In the system that performs face authentication, a face detector is generally present at a stage prior to a feature extractor. A configuration is often employed in which, after the face detector identifies a face area from an image and extracts a face area image, the face detector inputs the face area image to the feature extractor. In such a case, if an input image is a very blurred image, the face detector can also incorrectly detect a face. If a face is incorrectly detected, an image area where a face is not present is input as a face area image to the feature extractor.

A high similarity score may result from such an incorrect face detection image in a face authentication process.

For example, the face detector is likely to incorrectly detect the pattern of a simulacrum (a phenomenon where points and lines arranged in an inverted triangle look like the face of a person) as a face. It is easily imaginable that if similar simulacrum patterns are incorrectly detected from two images and input to the feature extractor, similar feature vectors are extracted from the input two images, resulting in a high similarity score. It is unnatural to compare images of such simulacrum patterns and determine that the simulacrum patterns are the same person, and it is natural to determine that the simulacrum patterns are different people. As described above, an incorrect face detection image can also be said to be an incorrect identification induction image.

The incorrect detection of a face occurs not only in a simulacrum pattern, but can occur also in a face image having an extremely large occlusion area, an image of the back of the head, and an image in which a plurality of faces is present in an overlapping manner (a plurality of faces is collectively detected as a single face image). Also with such an incorrect face detection image, it is difficult to extract information (a feature vector) distinguishing an individual from the incorrect detection image. Such an incorrect face detection image can also be said to be an incorrect identification induction image.

As described above, for the feature extractor based on the premise that a face image is input, an image of an object other than a face (an incorrect face detection image) or an image that makes it difficult to extract information distinguishing an individual from the image even if the image is a face image (a severely blurred image or an occlusion image) can be said to be an incorrect identification induction image.

It is not uncommon to encounter such an incorrect identification induction image during the evaluation of the object recognizer (the feature extractor). Thus, incorrect identification induction images can also be easily collected and accumulated in the evaluation work. Incorrect identification induction images can be collected automatically or manually.

As an example of a case where incorrect identification induction images are automatically collected, the following technique is conceivable. For example, if incorrect face detection images are collected as incorrect identification induction images, the incorrect face detection images can be automatically collected using evaluation images for the face detector. A grand truth (GT; a correct answer) is given to an evaluation image for the face detector at a face position. The face detector is evaluated based on whether a face is detected at this position. Thus, if detection results indicating the failure of detection of faces are collected during the evaluation of the face detector, incorrect identification induction images can be collected. Similarly, if a face is detected from an image in which no face appears input to the face detector, that means the incorrect detection of a face. Thus, the result of the detection can be collected.

For example, if severely blurred images are automatically collected as incorrect identification induction images, the images determined as blurred images by applying a blurring determiner that determines the blurring of images to the images of face detection results can be collected. The determination of the blurring of an image can be made using a known technique. For example, a technique can be used for applying an edge extraction filter, such as a Laplacian filter, to an image, then calculating the density of an edge, and based on the density of the edge, determining whether the image is a blurred image.

For example, if incorrect identification induction images are manually collected, the following technique can be used. If incorrect identification induction images are collected while a person views images of face detection results, the incorrect identification induction images can be collected based on whether information that allows the identification of an individual can be extracted from an image of the face detection result by viewing the image. It can be determined that sufficient information to identify an individual cannot be extracted from a severely blurred face image as described above, a face image in which an extremely large area is hidden, a face image in which the angle of the orientation of the face is extreme (a face image in which the orientation of the face is greatly shifted from the frontal direction), or a face image in which a plurality of faces appears. Such images may be manually collected as incorrect identification induction images.

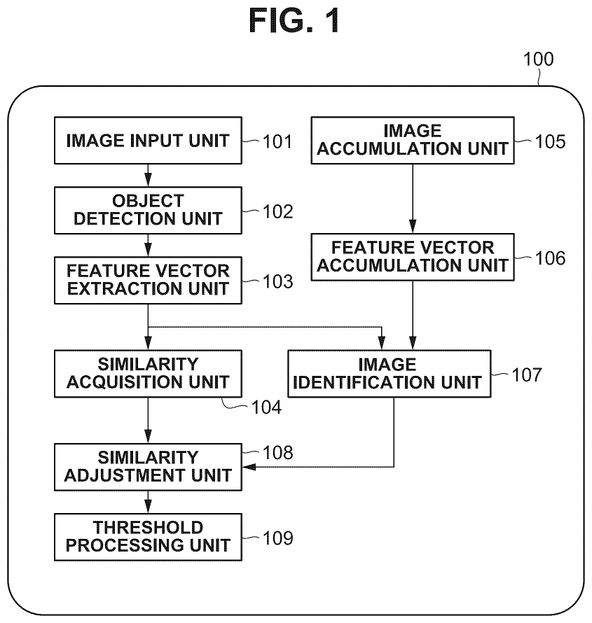

The information processing apparatus according to the first exemplary embodiment will now be described. FIG. 1 is a block diagram illustrating an example of the configuration of an information processing apparatus 100 according to the first exemplary embodiment. The information processing apparatus 100 includes an image input unit 101, an object detection unit 102, a feature vector extraction unit 103, a similarity acquisition unit 104, an image accumulation unit 105, a feature vector accumulation unit 106, an image identification unit 107, a similarity adjustment unit 108, and a threshold processing unit 109.

The image input unit 101 inputs an image as a processing target of object recognition (an image as a processing target of face authentication in this example). In the present exemplary embodiment, a reproduction image of a captured recorded image is input to the image input unit 101.

The object detection unit 102 detects a target object in an image input from the image input unit 101 (hereinafter also referred to as an “input image”), acquires a detection image of the target object by extracting an area including the target object from the input image, and outputs the detection image as an object area image. In the example of the present exemplary embodiment, the object detection unit 102 detects a face as a target object in the input image. As the technique for detecting the face, a known technique can be used. For example, the object detection unit 102 extracts shapes corresponding to the components of a face area, such as the nose, the mouth, and the eyes, from the input image and estimate the size of the face based on the sizes of both eyes and the distance between both eyes. Then, the object detection unit 102 can set an area surrounded by an area having the estimated size based on a position corresponding to the center of the nose in the input image as an image of the face area. The image of the face area detected by the object detection unit 102 is normalized to a certain size by a predetermined technique and output as a face area image.

The feature vector extraction unit 103 performs a feature vector extraction process on an object area image input from the object detection unit 102, acquires a feature vector of the input object area image, and outputs the feature vector. The feature vector is an example of feature information, and the feature vector extraction unit 103 is an example of an extraction unit that extracts feature information from an image. The feature vector extraction unit 103 is realized with a neural network for which feature extraction parameters obtained by learning using learning data are set in advance. That is, the feature vector extraction unit 103 is a trained model. In the example of the present exemplary embodiment, the feature vector extraction unit 103 performs the feature vector extraction process on a face area image input from the object detection unit 102, acquires a feature vector of the face area image, and outputs the feature vector.

Based on feature vectors obtained by the feature vector extraction unit 103, the similarity acquisition unit 104 acquires the similarity between two feature vectors derived from two images. Any method for obtaining the similarity is available. In the present exemplary embodiment, a method is selected for indicating that the higher the similarity is, the more similar to each other the feature amounts (the feature vectors) are, i.e., the more likely the faces in one image and the other image are to be the face of the same person. For example, there are a method for setting a value obtained by adding 1 to the cosine of the angle between two feature vectors as a similarity score (the range of the score is 0 to 2) and a method for setting the inverse of the Euclidean distance between two feature vectors as a similarity score.

The image accumulation unit 105 accumulates incorrect identification induction images. Incorrect identification induction images and the collection of incorrect identification induction images are as described above, and are not described in detail here. Images collected as incorrect identification induction images (evaluation images determined to be a cause to produce inappropriate results) in evaluating evaluation images are accumulated in the image accumulation unit 105. The feature vector accumulation unit 106 accumulates feature vectors of incorrect identification induction images accumulated in the image accumulation unit 105. The feature vector of an incorrect identification induction image accumulated in the feature vector accumulation unit 106 is acquired using a neural network for which the same feature extraction parameter as that of the feature vector extraction unit 103 is set, i.e., using the same trained model as that as the feature vector extraction unit 103. For example, the feature vector of an incorrect identification induction image can be acquired using the feature vector extraction unit 103. The image accumulation unit 105 is an example of a second accumulation unit, and the feature vector accumulation unit 106 is an example of a first accumulation unit.

Based on a feature vector of an object area image (a face area image in this example) obtained by the feature vector extraction unit 103 and a feature vector of an incorrect identification induction image accumulated in the feature vector accumulation unit 106, the image identification unit 107 identifies an inappropriate image for object recognition. The “inappropriate image” refers to an image having a feature vector similar to the feature vector of the incorrect identification induction image. Although an incorrect identification induction image that may induce incorrect identification is identified during the evaluation work, the same process cannot be performed during the actual operation of the system regarding face authentication. Thus, based on a feature vector of an already identified incorrect identification induction image, the image identification unit 107 identifies an object area image presumed to be similar to the incorrect identification induction image as an inappropriate image.

First, the image identification unit 107 acquires the similarity between the feature vector of the object area image obtained by the feature vector extraction unit 103 and the feature vector of the incorrect identification induction image accumulated in the feature vector accumulation unit 106. The technique for obtaining a similarity is not particularly limited. For example, if the same technique as that for the acquisition of a similarity performed by the similarity acquisition unit 104 is used, the similarity acquisition unit 104 can be used to acquire a similarity, which is desirable. Further, based on the acquired similarity between the feature vector of the object area image and the feature vector of the incorrect identification induction image, the image identification unit 107 determines whether the object area image is an inappropriate image. For example, if the acquired similarity is higher than a threshold (an inappropriate image determination threshold) set in advance, the image identification unit 107 determines that the object area image is an inappropriate image.

Generally, the image accumulation unit 105 accumulates a plurality of incorrect identification induction images, and it is assumed that feature vectors obtained from the plurality of incorrect identification induction images are accumulated in the feature vector accumulation unit 106. That is, it is assumed that the feature vector accumulation unit 106 accumulates a plurality of feature vectors. Thus, regarding a single object area image, a plurality of similarities between the object area image and the feature vectors of the incorrect identification induction images is also acquired, and a plurality of comparison results of comparing the similarities and the inappropriate image determination threshold is also present. Although various techniques as exemplified below are possible as the technique for handling the plurality of comparison results, a technique for obtaining the most appropriate result may be employed. For example, if at least one of the plurality of similarities is higher than the inappropriate image determination threshold, the image identification unit 107 can determine that the object area image is an inappropriate image. For example, if half the plurality of similarities is higher than the inappropriate image determination threshold, the image identification unit 107 can determine that the object area image is an inappropriate image.

Based on the determination result of the image identification unit 107, the similarity adjustment unit 108 adjusts the similarity acquired by the similarity acquisition unit 104. As described above, regarding incorrect identification induction images, even if the similarity is high, it is natural to determine that the people in the images are different people, not the same person. Similarly, also regarding an inappropriate image similar to an incorrect identification induction image, it should be determined that the person in the image is a different person, not the same person. The similarity adjustment unit 108 adjusts the similarity score regarding the inappropriate image so that it is determined that the person in the image is a different person. The adjustment method is not particularly limited. In the present exemplary embodiment, as an example, the adjustment is made as follows.

Since the similarity is acquired by the similarity acquisition unit 104 regarding two object area images, the results of determining whether an object area image is an inappropriate image for the two object area images are also sent from the image identification unit 107 to the similarity adjustment unit 108. If both two object area images are determined to be inappropriate images, the similarity adjustment unit 108 sets the similarity score regarding the two object area images to 0 (multiplies the similarity score acquired by the similarity acquisition unit 104 by 0). If either on the two object area images is determined to be an inappropriate image, the similarity adjustment unit 108 sets the similarity score regarding the two object area images to half (½) (multiplies the similarity score acquired by the similarity acquisition unit 104 by 0.5). If neither of the two object area images is determined to be an inappropriate image, the similarity adjustment unit 108 does not adjust the similarity score regarding the two object area images (maintains the similarity score acquired by the similarity acquisition unit 104).

The similarity adjustment unit 108 thus adjusts the similarity score to adjust the similarity score related to an inappropriate image so that the value of the similarity score is small. The similarity score subjected to the adjustment process by the similarity adjustment unit 108 is output as the adjusted similarity score.

Based on the adjusted similarity score input from the similarity adjustment unit 108, the threshold processing unit 109 determines whether the people having the faces appearing in two object area images are a person or different people. The threshold processing unit 109 compares the adjusted similarity score with a threshold (a face authentication determination threshold) set in advance and determines whether the two object area images are images of a person or images of different people. If the adjusted similarity score is higher than the face authentication determination threshold, the threshold processing unit 109 determines that the people having the faces appearing in the two object area images are a person. If the adjusted similarity score is lower than the face authentication determination threshold, the threshold processing unit 109 determines that the people having the faces appearing in the two object area images are different people. It can be determined in advance whether to determine that the people having the faces appearing in the two object area images are a person or different people when the adjusted similarity score is the same as the face authentication determination threshold.

If an image similar to an incorrect identification induction image is input as an image as a processing target during the actual operation of face authentication by the information processing apparatus 100 illustrated in FIG. 1, the image is determined to be an inappropriate image, and the similarity score is adjusted so that the value of the similarity score is small. This adjustment of the similarity score reduces the possibility that the adjusted similarity score related to the inappropriate image will exceed the face authentication determination threshold. As a result, the person in the image is likely to be determined to be a different person in face authentication. The information processing apparatus 100 illustrated in FIG. 1 can determine an inappropriate image even during the actual operation of face authentication, preventing the output of an inappropriate face authentication result produced by an incorrect identification induction image during the evaluation.

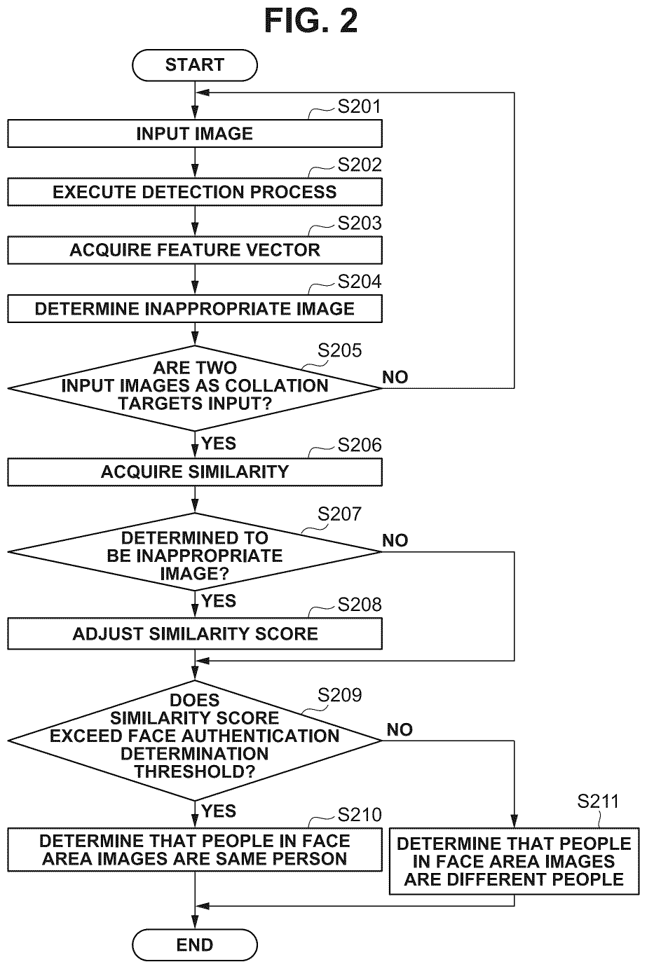

With reference to FIG. 2, the operation of the information processing apparatus 100 illustrated in FIG. 1 will now be described. FIG. 2 is a flowchart illustrating an example of the processing of the information processing apparatus 100 illustrated in FIG. 1. FIG. 2 illustrates the procedure of a face authentication process for determining whether faces in face images present in two input images are the face of a person or the faces of different people. For simple description, the description is given on the assumption that a single face image appears in a single input image.

In step S201, the image input unit 101 inputs an image as a target of face authentication.

In step S202, the object detection unit 102 performs a detection process for detecting a face as a target object in the image input in step S201 (the input image), normalizes the image of a detected face area to a certain size by a predetermined technique, and outputs the image of the detected face area as a face area image. If no face is detected in the input image, the subsequent processing is skipped.

In step S203, the feature vector extraction unit 103 performs a feature vector extraction process on the face area image obtained in step S202, acquiring a feature vector of the face area image.

In step S204, the image identification unit 107 determines whether the currently input face area image is an inappropriate image. The procedure for determining whether the currently input face area image is an inappropriate image has already been described in detail, and thus is not described in detail here. The image identification unit 107 makes the determination by acquiring the similarity between the feature vector of the face area image obtained by the feature vector extraction unit 103 and a feature vector of each of incorrect identification induction images accumulated in the feature vector accumulation unit 106 and comparing the acquired similarity with the inappropriate image determination threshold.

In step S205, the information processing apparatus 100 determines whether the processes regarding the acquisition of a feature vector and the determination of an inappropriate image are performed on two input images. That is, the information processing apparatus 100 determines whether two input images as collation targets are input and the above processes are performed on each input image. If it is determined that the processes are performed on the two input images (YES in step S205), the processing proceeds to step S206. If, on the other hand, it is determined that the processes are performed on only one of the input images (NO in step S205), the processing returns to step S201. In step S201, the processes of steps S201 to S204 are performed on the other of the input images as the collation targets.

In step S206, based on the feature vectors obtained from the two face area images, the similarity acquisition unit 104 acquires the similarity between the two feature vectors.

In step S207, with reference to the results of determining an inappropriate image in step S204, the similarity adjustment unit 108 determines whether the currently input two face area images are determined to be inappropriate images. Based on the results of determining an inappropriate image by the image identification unit 107, the similarity adjustment unit 108 determines whether at least one of the currently input two face area images is determined to be an inappropriate image. If the similarity adjustment unit 108 determines that there is a face area image determined to be an inappropriate image, i.e., at least one of the face area images is determined to be an inappropriate image (YES in step S207), the processing proceeds to step S208 so that the similarity score is adjusted. If the similarity adjustment unit 108 determines that there is no face area image determined to be an inappropriate image, i.e., neither of the two face area images is determined to be an inappropriate image (NO in step S207), the processing proceeds to step S209 because the similarity score does not need to be adjusted.

In step S208, the similarity adjustment unit 108 adjusts the similarity acquired in step S206. In the example of the present exemplary embodiment, if at least one of the two face area images is determined to be an inappropriate image, the similarity adjustment unit 108 adjusts the similarity score indicating the similarity between the feature vectors of the two face area images so that the value of the similarity score is small.

In step S209, the threshold processing unit 109 compares the similarity score regarding the feature vectors of the two face area images with the face authentication determination threshold and determines whether the similarity score exceeds the face authentication determination threshold. In the process of step S209, if at least one of the two face area images is determined to be an inappropriate image, the adjusted similarity score adjusted in step S208 and the face authentication determination threshold are compared with each other. If neither of the two face area images is determined to be an inappropriate image, the similarity score acquired in step S206 and the face authentication determination threshold are compared with each other.

If it is determined that the similarity score exceeds the face authentication determination threshold (YES in step S209), the processing proceeds to step S210. In step S210, the threshold processing unit 109 determines that the people in the two face area images are a person. If, on the other hand, it is determined that the similarity score does not exceed the face authentication determination threshold (NO in step S209), the processing proceeds to step S211. In step S211, the threshold processing unit 109 determines that the people in the two face area images are different people.

According to the present exemplary embodiment, while an evaluation using evaluation images is made, determination can be made whether a face area image is an inappropriate image using incorrect identification induction images accumulated as evaluation images that produces inappropriate results. Further, if it is determined that the face area image is an inappropriate image, the similarity between two face area images can be adjusted.

This allows the similarity score regarding a face area image determined to be an inappropriate image to be adjusted small. As a result, the people in two face area images are likely to be determined to be different people. That is, the face authentication results of very blurred images or incorrect detection images in face detection are likely to be determined to be different people, providing an improved reliability of the actual operation of the face authentication system.

There are various techniques as techniques for determining to be inappropriate image performed by the image identification unit 107. That is, there are various techniques for determining what technique (rule) is to be used to determine an inappropriate image based on a plurality of similarities acquired using feature vectors of a plurality of incorrect identification induction images. The technique for determining an inappropriate image is not limited to the above technique. For example, based on the ratio of similarities exceeding the inappropriate image determination threshold to a plurality of similarities, it can be determined whether a face area image is an inappropriate image.

There are also various techniques as techniques for adjusting the similarity score performed by the similarity adjustment unit 108. Further, there are also various techniques as techniques for determining to what degree the similarity score is to be adjusted (the reduction rate). This adjustment technique is not limited to the exemplified technique, either. For example, if it is determined that an input face area image is an inappropriate image, the similarity score can be uniformly adjusted, regardless of the number of images.

Further, the similarity adjustment unit 108 can determine reduction rates of the similarity scores based on the input plurality of similarities by the image identification unit 107 outputting a plurality of similarities themselves to the similarity adjustment unit 108. For example, a neural network to which a plurality of similarities is input and from which reduction rates of the similarity scores are output may be designed, and a parameter for the neural network can be determined by the following technique termed cross-validation. In the cross-validation, evaluation data used to collect an incorrect identification induction image is divided into learning data and validation data, an optimal parameter is learned using the learning data, and the result of the learning is evaluated using the validation data. Use of the cross-validation allows an optimal technique to be selected while reducing overfitting to the evaluation data to some degree, which is desirable.

Also in a second exemplary embodiment, a description will be given using as an example a case where an information processing apparatus according to the present exemplary embodiment is applied to a system that performs face authentication (individual authentication). In the first exemplary embodiment, an example has been illustrated where the information processing apparatus is applied to face authentication in which it is determined whether people having faces in the two input images are a person. In the second exemplary embodiment, an example will be illustrated where the information processing apparatus is applied to face authentication in which face images are registered as registered images in advance and it is determined whether a person having a face in an input image is the same person as that in any of the registered images or is different from those in the registered images. Particularly, a detailed description will be given of a case where the information processing apparatus according to the present exemplary embodiment is applied to a face image registration process performed in advance.

First, the face image registration process will be described. The “face image registration process” refers to the process of registering in advance a face image of a person that should be identified by face authentication in the system that performs face authentication. The registered face image (the registered image) will be collated with an input image (an image in which it should be known who appears in the image) in a subsequent face authentication process many times. Thus, the use of a high-quality image (an image that is not severely blurred or an image in which a large area is not hidden) as the registered image greatly influences the authentication accuracy of face authentication. In the present exemplary embodiment, a description will be given using as an example the process of determining and identifying an inappropriate image when the face image registration process is performed, and not employing the identified inappropriate image as a registered image.

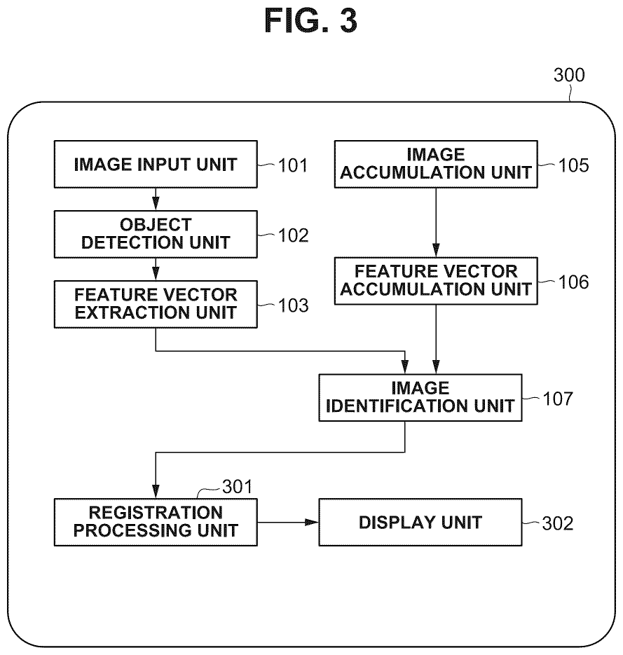

FIG. 3 is a block diagram illustrating an example of the configuration of an information processing apparatus 300 according to the second exemplary embodiment. In FIG. 3, components similar to the components illustrated in FIG. 1 are denoted by the same referential numbers, and are not redundantly described. The information processing apparatus 300 includes an image input unit 101, an object detection unit 102, a feature vector extraction unit 103, an image accumulation unit 105, a feature vector accumulation unit 106, an image identification unit 107, a registration processing unit 301, and a display unit 302. In the following description, an image input to be set as a registered image is also referred to as a “registration candidate image”.

Based on the determination result of the image identification unit 107, the registration processing unit 301 determines whether to register a currently input registration candidate image as a registered image. If the image identification unit 107 determines that the registration candidate image is not an inappropriate image, the registration processing unit 301 performs a registration process for registering the registration candidate image. If, on the other hand, the image identification unit 107 determines that the registration candidate image is an inappropriate image, the registration processing unit 301 does not perform the registration process for registering the registration candidate image. The registration processing unit 301 also outputs to the display unit 302 the result of determining whether the registration candidate image is registered as a registered image.

In the registration process for registering the registration candidate image, the registration candidate image can be saved as it is as registration information, or a feature vector of the registration candidate image can be saved as the registration information. If the actual image is saved as the registration information, there is an advantage that the registered image can continue to be used even if the processing of the feature vector extraction unit 103 is updated while the feature vector of the registered image needs to be acquired every time the face authentication process is performed. On the other hand, if the feature vector is saved as the registration information, the feature vector of the registered image does not need to be acquired every time the face authentication process is performed, and the amount of processing in the face authentication process can be reduced.

According to the result of determining whether the registration candidate image is registered from the registration processing unit 301, the display unit 302 displays the result of determining whether the currently input registration candidate image is registered. The result is displayed to notify a user (a person attempting to register the image) of whether the registration of the registration candidate image as a registered image is successful. If the registration candidate image is determined to be an inappropriate image and is not registered, it is necessary for the user to perform the registration process again using another image as a registration candidate image.

According to the thus configured information processing apparatus 300, if a face image (a face area image) similar to an incorrect identification induction image is input as a registration candidate image in the face image registration process, it is possible to determine the registration candidate image to be an inappropriate image and refuse to register the registration candidate image. Consequently, it is possible to prevent a low-quality image (a severely blurred image or an image in which a large area is hidden) from being set as a registered image, and avoid the deterioration of the authentication accuracy of the system that performs face authentication.

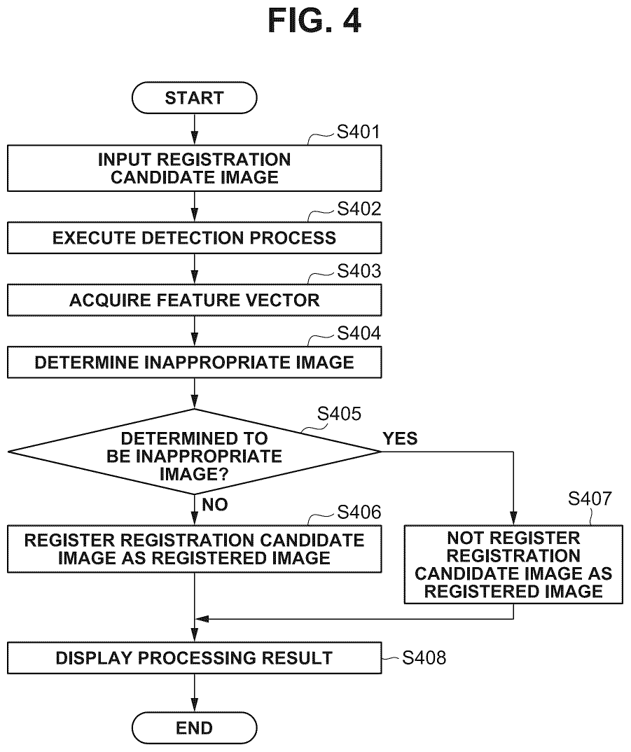

The operation of the information processing apparatus 300 illustrated in FIG. 3 will be described with reference to FIG. 4. FIG. 4 is a flowchart illustrating an example of the processing of the information processing apparatus 300 illustrated in FIG. 3. FIG. 4 illustrates the procedure of the face image registration process.

In step S401, the image input unit 101 inputs a registration candidate image.

In step S402, the object detection unit 102 performs a detection process for detecting a face in the input registration candidate image. If no face is detected in the input image, the processing proceeds to step S407. In step S407, the registration candidate image is not employed as a registered image.

In step S403, the feature vector extraction unit 103 performs a feature vector extraction process on the registration candidate image and acquires a feature vector of the registration candidate image.

In step S404, the image identification unit 107 determines whether the currently input registration candidate image is an inappropriate image. The determination of whether the registration candidate image is an inappropriate image is made similarly to the first exemplary embodiment.

In step S405, based on the determination result of the image identification unit 107, the registration processing unit 301 determines whether the registration candidate image is determined to be an inappropriate image. If the registration processing unit 301 determines that the registration candidate image is not determined to be an inappropriate image (NO in step S405), the processing proceeds to step S406. If, on the other hand, the registration processing unit 301 determines that the registration candidate image is determined to be an inappropriate image (YES in step S405), the processing proceeds to step S407.

In step S406, the registration processing unit 301 registers the registration candidate image as a registered image. The registration processing unit 301 also outputs to the display unit 302 the processing result indicating that the registration candidate image is registered as a registered image.

In step S407, the registration processing unit 301 does not register the registration candidate image as a registered image. The registration processing unit 301 also outputs to the display unit 302 the process result indicating that the registration candidate image is not registered as a registered image.

In step S408, the display unit 302 displays the result of the registration process for registering the registration candidate image.

According to the present exemplary embodiment, if an image similar to an incorrect identification induction image is input as a registration candidate image, it is possible to determine the registration candidate image as an inappropriate image and refuse to register the registration candidate image determined to be the inappropriate image. If a meaning is attached to an incorrect identification induction image in advance, and if the registration of a registration candidate image is refused, it is possible to display not only the processing result indicating the refusal of the registration, but also the reason for the refusal of the registration on the display unit 302. For example, if reasons, such as “the blurring is severe” and “a hidden area is large”, are given to or associated with incorrect identification induction images, it is possible to display the reason for the refusal of the registration depending on which of the incorrect identification induction images the registration candidate image is similar to.

If it is determined that the registration candidate image is similar to the incorrect identification induction image of which the blurring is severe, it is also possible to display the reason for the refusal of the registration, such as “the blurring of the registration candidate image seems to be too severe”. If the reason for the refusal of the registration of the registration candidate image is understood, it is clear how to remedy the situation. Thus, it is possible to achieve a system friendly for a user (a person attempting to register the image).

In a third exemplary embodiment, a description will be given using as an example a case where an information processing apparatus according to the present exemplary embodiment is applied to a system that manages learning images for face authentication (individual authentication). In the present exemplary embodiment, an example will be illustrated where an inappropriate image is identified from among learning images for face authentication (individual authentication), and the identified image is excluded from the learning images. Generally, an enormous number of learning images are required to train a neural network. In the learning images, there may be an incorrect label image (a learning image in which the correspondence between the image and the label of the image is incorrect) or an image inappropriate for use in learning face authentication (an incorrect face detection image or an image that makes it difficult to extract information that allows the distinction of an individual from the image even if the image is a face image). It is known that the presence of such an image in the learning images greatly influences the accuracy of face authentication obtained as a result of learning.

Thus, to achieve accurate face authentication, it is necessary to prepare many high-quality learning images without an incorrect label. It is, however, impossible to check an incorrect label or check image quality by visually checking an enormous number of learning images. Thus, there is an issue with the efficient exclusion of an incorrect label image or a low-quality image from all the learning images. As the technique for excluding such an inappropriate image from the learning images, the information processing apparatus according to the present exemplary embodiment is applied. The exclusion of an incorrect label image or a low-quality image from the learning images as described above is also termed the cleansing of the learning images.

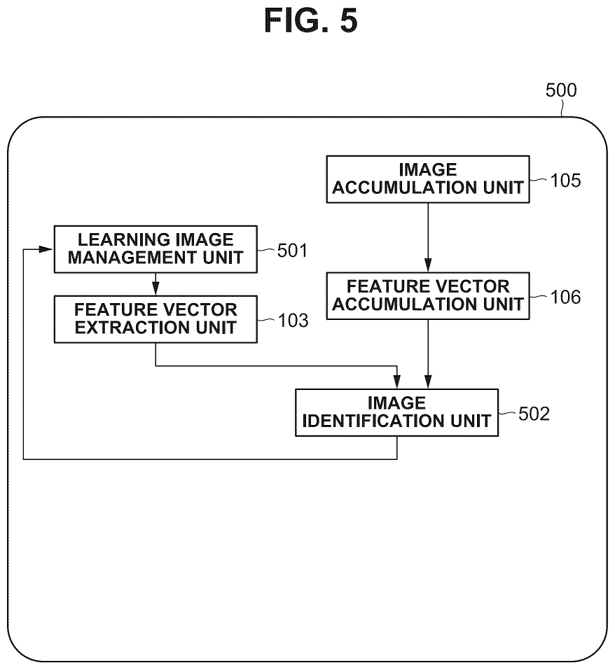

FIG. 5 is a block diagram illustrating an example of the configuration of an information processing apparatus 500 according to the third exemplary embodiment. In FIG. 5, components similar to the components illustrated in FIG. 1 are denoted by the same referential numbers, and are not redundantly described. The information processing apparatus 500 includes a feature vector extraction unit 103, an image accumulation unit 105, a feature vector accumulation unit 106, a learning image management unit 501, and an image identification unit 502.

The learning image management unit 501 manages a learning image and a class label (a person identifier (ID)) of the learning image in association with each other. For simple description, based on the results of face detection, the learning image management unit 501 manages face area images normalized to a certain size by a predetermined technique as learning images. The learning image management unit 501 outputs any of the managed learning images to the feature vector extraction unit 103. If the learning image management unit 501 receives from the image identification unit 502 the determination that the output learning image is an inappropriate image, the learning image management unit 501 excludes the image from the learning images. If the learning image management unit 501 does not receive from the image identification unit 502 the determination that the output learning image is an inappropriate image, the learning image management unit 501 does not exclude the image from the learning images.

Based on a feature vector of a learning image obtained by the feature vector extraction unit 103 and a feature vector of an incorrect identification induction images accumulated in the feature vector accumulation unit 106, the image identification unit 502 identifies an inappropriate image. The image identification unit 502 acquires the similarity between the feature vector of the learning image obtained by the feature vector extraction unit 103 and the feature vector of the incorrect identification induction image accumulated in the feature vector accumulation unit 106, and based on the acquired similarity, determines whether the learning image is an inappropriate image. The image identification unit 502 notifies the learning image management unit 501 of the result of determining whether the learning image is an inappropriate image. The technique for acquiring the similarity and the technique for determining an inappropriate image based on the similarity can be similar to the techniques in the above exemplary embodiment, and are not particularly limited.

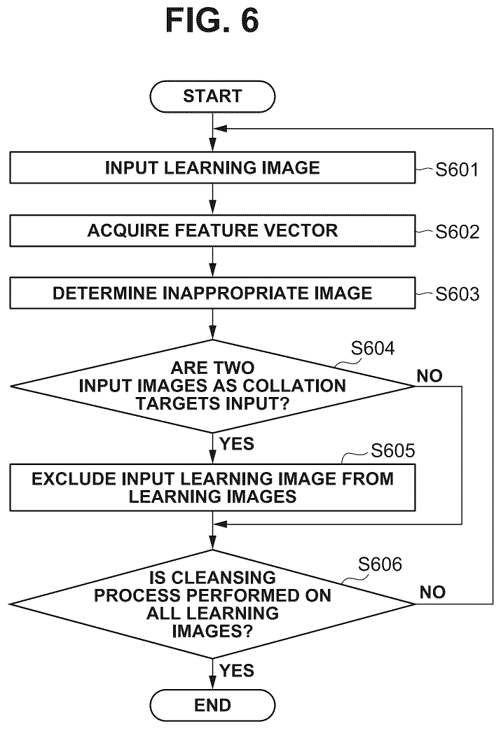

The operation of the information processing apparatus 500 illustrated in FIG. 5 will be described with reference to FIG. 6. FIG. 6 is a flowchart illustrating an example of the processing of the information processing apparatus 500 illustrated in FIG. 5.

In step S601, the learning image management unit 501 inputs a single learning image that is not processed from among all learning images.

In step S602, the feature vector extraction unit 103 performs a feature vector extraction process on the learning image input in step S601 and acquires a feature vector of the input learning image.

In step S603, the image identification unit 502 determines whether the currently input learning image is an inappropriate image. For example, the determination of whether the learning image is an inappropriate image can be made similarly to the first exemplary embodiment.

In step S604, based on the determination result of which the learning image management unit 501 is notified by the image identification unit 502, the learning image management unit 501 determines whether the input learning image is determined to be an inappropriate image. If the learning image management unit 501 determines that the input learning image is determined to be an inappropriate image (YES in step S604), the processing proceeds to step S605. If, on the other hand, the learning image management unit 501 determines that the input learning image is not determined to be an inappropriate image (NO in step S604), the processing proceeds to step S606.

In step S605, the learning image management unit 501 excludes the learning image input this time from the learning images.

In step S606, the learning image management unit 501 determines whether the cleansing process is performed on all the learning images. If the learning image management unit 501 determines that the cleansing process is not performed on all the learning images, i.e., there is a learning image that is not processed (NO in step S606), the processing returns to step S601. Then, the processes of step S601 and the subsequent steps are performed on the learning image that is not processed. If, on the other hand, the learning image management unit 501 determines that the cleansing process is performed on all the learning images (YES in step S606), the processing illustrated in FIG. 6 (the cleansing process on the learning images) ends.

According to the present exemplary embodiment, it can be determined whether an inappropriate image similar to an incorrect identification induction image is present in learning images, and an image identified as an inappropriate image can be excluded from the learning images. Consequently, a high-quality learning image can be obtained by efficiently excluding a low-quality image from all the enormous number of learning images. Learning performed using the learning images from which the inappropriate image is excluded can achieve accurate face authentication.

Also in a fourth exemplary embodiment, a description will be given using as an example a case where an information processing apparatus according to the present exemplary embodiment is applied to a system that manages learning images for face authentication (individual authentication). In the fourth exemplary embodiment, to identify an inappropriate image from among learning images, a representative vector obtained as a result of learning is used. Although the details of the representative vector will be described below, the number of representative vectors obtained as a result of learning is the same as the number of classes (the number of person IDs) present in the learning images. That is, a single representative vector is present for a single class label (person ID). In the third exemplary embodiment, the similarity between a feature vector of a learning image itself and a feature vector of an incorrect identification induction image is acquired, identifying an inappropriate image. In the fourth exemplary embodiment, the similarity between a representative vector and a feature vector of an incorrect identification induction image is acquired, identifying an inappropriate image.

Generally, learning images include a plurality of images in each class, and thus, the number of representative vectors is very small relative to the number of feature vectors of the learning images. Thus, the present exemplary embodiment has an advantage that the number of calculations of the acquisition of the similarity to identify an inappropriate image can be reduced compared to the third exemplary embodiment.

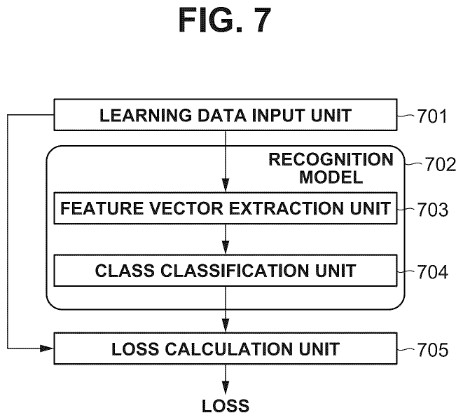

FIG. 7 is a diagram illustrating an example of a configuration regarding a learning process in the face authentication system to which the information processing apparatus according to the present exemplary embodiment is applied.

A learning data input unit 701 manages learning data for face authentication. The learning data for face authentication associates a face image with a class label (an individual ID) of the face image. The learning data input unit 701 supplies a face image to a recognition model 702 and also outputs a class label of the face image to a loss calculation unit 705.

The recognition model 702 includes a feature vector extraction unit 703 and a class classification unit 704. “Learning” means adjustment of parameters included in the feature vector extraction unit 703 and the class classification unit 704 (generally, a large number of parameters are present) to make small a loss value calculated by the loss calculation unit 705.

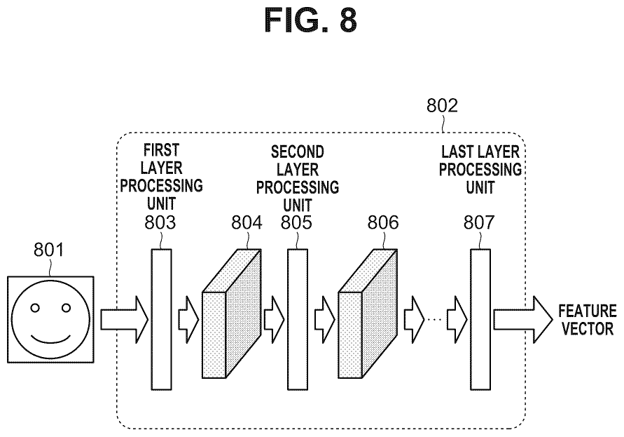

The feature vector extraction unit 703 extracts information (a feature vector) identifying an individual from the input face image. After the learning ends, the feature vector extraction unit 703 is used as the feature vector extraction unit 103 illustrated in each of the first to third exemplary embodiments. The processing of the feature vector extraction unit 703 will be described with reference to FIG. 8.

FIG. 8 is a schematic diagram illustrating the processing of the feature vector extraction unit 703. An image 801 is a face image input to a feature vector extraction unit 802 (703). The face image 801 is the output of the learning data input unit 701.

The feature vector extraction unit 802 extracts a feature vector using a calculation technique termed a convolutional neural network (CNN), which is a type of a deep network. The CNN repeatedly performs processing including a convolution process, a non-linear process, and a pooling process on an input image, extracting abstracted information from the input image. The processing unit including the convolution process, the non-linear process, and the pooling process is often referred to as a “layer”. Although there are many known techniques as the non-linear process to be used, for example, a technique termed rectified linear unit (ReLU) can be used. Although there are many known techniques as the pooling process, for example, a technique termed max pooling can be used.

In the feature vector extraction unit 802, a first layer processing unit 803 performs the convolution process, the non-linear process, and the pooling process on the input face image 801. The first layer processing unit 803 outputs a first intermediate map 804, and the first intermediate map 804 is input to a second layer processing unit 805. Further, similarly to the first layer processing unit 803, the second layer processing unit 805 performs the convolution process, the non-linear process, and the pooling process on the first intermediate map 804 and outputs a second intermediate map 806. The feature vector extraction unit 802 repeatedly performs such hierarchical processes on the input face image 801, extracting a feature vector that allows the identification of an individual. A last layer processing unit 807 performs a full connection calculation process and extracts a feature vector of the face image 801. In the present exemplary embodiment, as an example, the number of dimensions (the length) of the extracted feature vector is d.

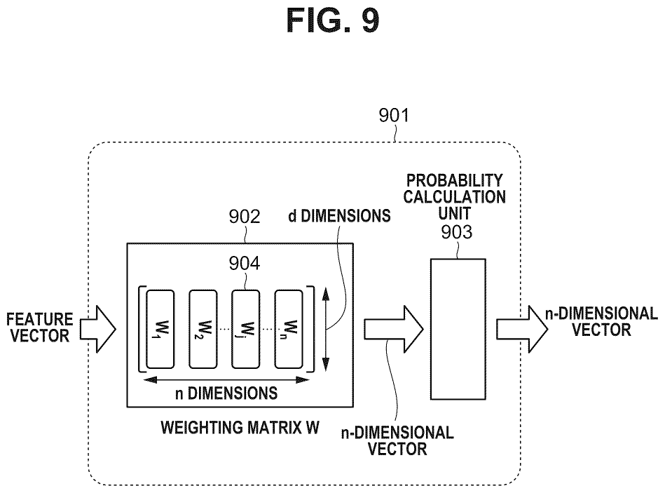

Referring back to FIG. 7, based on the feature vector extracted by the feature vector extraction unit 703, the class classification unit 704 estimates a class to which the feature vector belongs. The estimation of the class corresponds to the estimation of a person label in the case of the face authentication described in the present exemplary embodiment. The processing of the class classification unit 704 will be described with reference to FIG. 9.

FIG. 9 is a schematic diagram illustrating the processing of the class classification unit 704. A class classification unit 901 (704) performs calculations using a matrix termed a weighting matrix and performs class classification.

In the class classification unit 901, a representative vector holding unit 902 calculates the product of an input feature vector and a weighting matrix held in the representative vector holding unit 902. The size of the weighting matrix is a (d×n) size where the input feature vector has d dimensions and the number of class labels in the learning data is n. Thus, an n-dimensional vector is obtained from the product of the feature vector and the weighting matrix. The representative vector holding unit 902 outputs the n-dimensional vector. The n-dimensional vector is referred to as a “logit”. The representative vector holding unit 902 outputs the logit to a probability calculation unit 903.

The calculations performed by the representative vector holding unit 902 can be represented by the following equations. When the weighting matrix is W, the weighting matrix W can be represented as follows.

$$\begin{matrix}[ Math . 1 ] & \\ W = [ {W}_{1} , {W}_{2} , ... , {W}_{n} ] & ( equation 1 )\end{matrix}$$

$${W}_{j} = {( {W}_{1 , j} , {W}_{2 , j} , ... , {W}_{d , j} )}^{T} ( 1 \leq j \leq n ) \qquad ( equation 2 )$$

When the feature vector (d dimensions) input to the representative vector holding unit 902 is f, and the logit (n dimensions) output from the representative vector holding unit 902 is g, the feature vector f and the logit g can be represented as follows.

### [Math. 2]

$$\begin{matrix}[ Math . 2 ] & \\ f = ( {f}_{1} , {f}_{2} , ... , {f}_{d} ) & ( equation 3 )\end{matrix}$$

$$g = ( {g}_{1} , {g}_{2} , ... , {g}_{n} ) \qquad ( equation 4 )$$

$$g = f * W \qquad ( equation 5 )$$

(* represents the product of the vector and the matrix)

The element W_{i,j} (1≤i≤d, 1≤j≤n) of the weighting matrix W is obtained by learning. n column vectors Wⱼ (the size of each column vector is d dimensions) included in the weighting matrix W obtained after the learning ends are referred to as “representative vectors”. For example, a column vector 904 in a j-th column illustrated in FIG. 9 is referred to as “a representative vector of a class label j”.

The probability calculation unit 903 calculates the softmax of the logit g output from the representative vector holding unit 902 as illustrated in the following equations 6 and 7 and calculates the class classification probability.

$$\begin{matrix}[ Math . 3 ] & \\ h = ( {h}_{1} , {h}_{2} , ... , {h}_{n} ) & ( equation 6 )\end{matrix}$$

$${h}_{j} = \frac{exp ( {g}_{j} )}{{\sum }_{j = 1}^{n} exp ( {g}_{j} )} \qquad ( equation 7 )$$

The class classification unit 901 performs the above calculations.

Referring back to FIG. 7, the softmax h (an n-dimensional vector) calculated by the class classification unit 704 as described above is input to the loss calculation unit 705, and the class label corresponding to the face image based on which the softmax h is calculated is also input from the learning data input unit 701. The type of the loss calculated by the loss calculation unit 705 according to the present exemplary embodiment is not particularly limited so long as the loss is loss for class classification. In the present exemplary embodiment, as an example, general softmax cross-entropy loss is calculated as the loss for class classification.

If a class label c is input from the learning data input unit 701, and the softmax h corresponding to the class label c is input from the class classification unit 704, softmax cross-entropy loss Lₛ can be represented by the following equation 8.

$$\begin{matrix}[ Math . 4 ] & \\ {L}_{s} = - log \{ \frac{exp ( {g}_{c} )}{{\sum }_{j = 1}^{n} exp ( {g}_{j} )} \} & ( equation 8 )\end{matrix}$$

In the learning, the parameters included in the recognition model 702 are adjusted to make small the loss calculated by the loss calculation unit 705. In the present exemplary embodiment, the manner of the learning does not particularly matter. For example, the learning can be performed by sequentially updating the parameters by a stochastic gradient method, using a general error backpropagation method. According to equation 8, the greater the value g_{c} is, the smaller the loss is. That is, the greater the element included in the logit g calculated by equation 5 and corresponding to the class label is, the smaller the loss is. The value g_{c} is calculated as the inner product of a feature vector of the class label c and a representative vector of the class label c as illustrated in equation 9.

$$\begin{matrix}[ Math . 5 ] & \\ {g}_{c} = {f}_{c , k} \cdot {W}_{c} & ( equation 9 )\end{matrix}$$

In equation 9, f_{c,k} represents a feature vector extracted from a k-th learning image belonging to the class c.

As described above, the learning proceeds so that the value g_{c} calculated by equation 9 becomes greater. In equation 9, the inner product of the feature vector f_{c,k} corresponding to the learning image associated with the class label c and the representative vector We of the class label c is calculated. Thus, if the learning proceeds in the direction in which the result of the inner product g_{c} becomes greater, both vectors (f_{c,k} and W_{c}) of which the inner product is calculated would be directed in the same direction. Generally, there is a plurality of learning images (face images) belonging to the class c, so that a plurality of feature vectors belonging to the class c is also extracted. The learning is performed so that the representative vector W_{c} is directed in the same direction as the plurality of feature vectors. Thus, if the learning proceeds, the representative vector W_{c} is expected to be directed in approximately the same direction as many feature vectors of the class label c. That is, the direction of a feature vector of the class label c can be understood by viewing the representative vector We without viewing the plurality of feature vectors of the class label c, and thus, the representative vector W_{c} can be said to be a vector representing the class c. That is, the representative vector W_{c} can be said to be a vector representing the face images of the people belonging to the class c.

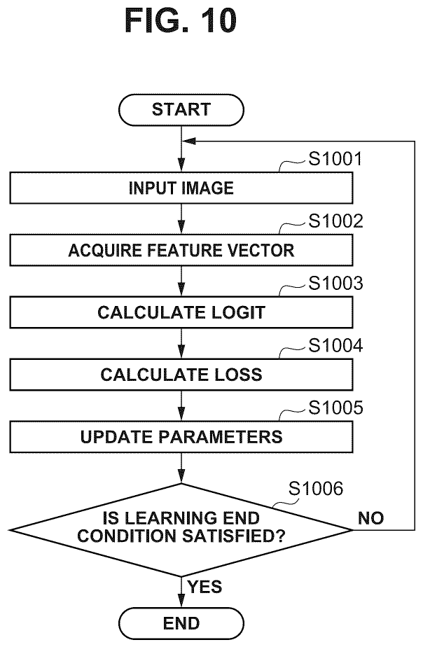

The procedure of the processing in the learning will now be described with reference to FIG. 10. FIG. 10 is a flowchart illustrating an example of the processing in the learning.

In step S1001, the learning data input unit 701 inputs a learning image (a face image) to the feature vector extraction unit 703.

In step S1002, the feature vector extraction unit 703 acquires a feature vector of the learning image input in step S1001.

In step S1003, based on the feature vector acquired in step S1002, the class classification unit 704 calculates a logit.

In step S1004, based on the logit calculated in step S1003 and a class label, the loss calculation unit 705 calculates loss.

In step S1005, based on the loss calculated in step S1004, the parameters for the feature vector extraction unit 703 and the class classification unit 704 are updated.

In step S1006, it is determined whether a learning end condition is satisfied. Any learning end condition can be used, so that a known learning end condition can be used for the determination. For example, the learning end condition can be that if the parameters are updated a certain number of times, the learning ends. If the learning end condition is satisfied (YES in step S1006), the pre-learning ends. If the learning end condition is not satisfied (NO in step S1006), the processing returns to step S1001. In step S1001, the learning continues.

This is a description of the face authentication learning.

If the learning is performed as described above, the class classification unit 704 obtains the matrix W (equation 1) where the columns are representative vectors of respective classes. In the present exemplary embodiment, an example will be described where an inappropriate image (an incorrect label image or a low-quality image) is identified among the learning images using these representative vectors and excluded from the learning images.

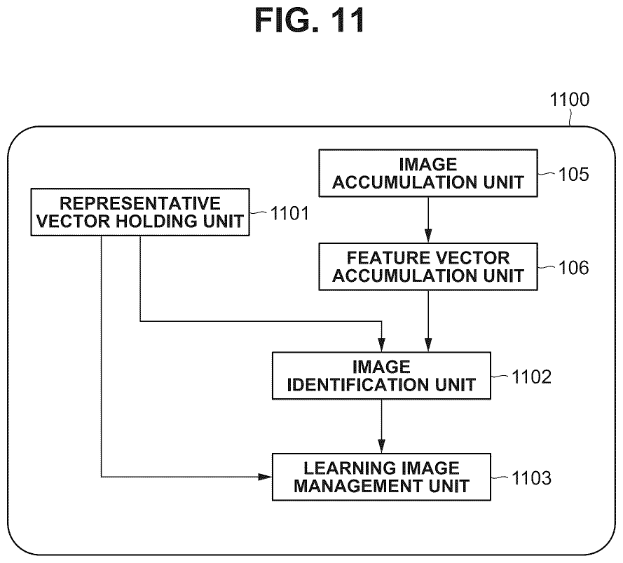

FIG. 11 is a block diagram illustrating an example of the configuration of an information processing apparatus 1100 according to the fourth exemplary embodiment. In FIG. 11, components similar to the components illustrated in FIG. 1 are denoted by the same referential numbers, and are not redundantly described. The information processing apparatus 1100 includes an image accumulation unit 105, a feature vector accumulation unit 106, a representative vector holding unit 1101, an image identification unit 1102, and a learning image management unit 1103.

The representative vector holding unit 1101 holds a learned representative vector obtained by learning as described above. The representative vector is an example of representative feature information. The main function of the representative vector holding unit 1101 has been described in the section of the representative vector holding unit 902 in FIG. 9, and thus is not described. The representative vector holding unit 1101 also has the function of outputting the representative vector held in the representative vector holding unit 1101 and a class label corresponding to the representative vector. For example, the representative vector holding unit 1101 holds a weighting matrix as represented by equation 1, and subsequently outputs the weighting matrix column by column as a representative vector and also outputs a column number corresponding to the representative vector as a class label.

Based on a representative vector input from the representative vector holding unit 1101 and a feature vector of an incorrect identification induction image accumulated in the feature vector accumulation unit 106, the image identification unit 1102 identifies an inappropriate image. The image identification unit 1102 acquires the similarity between the representative vector input from the representative vector holding unit 1101 and the feature vector of the incorrect identification induction image accumulated in the feature vector accumulation unit 106, and based on the acquired similarity, determines whether the learning image is an inappropriate image. The technique for acquiring the similarity and the technique for determining an inappropriate image based on the similarity can be similar to the techniques in the above exemplary embodiments, and are not particularly limited.

The learning image management unit 1103 manages a learning image and a class label of the learning image in association with each other. Also in this case, similarly to the third exemplary embodiment, based on the results of face detection, the learning image management unit 1103 manages face area images normalized to a certain size by a predetermined technique as learning images. The learning image management unit 1103 excludes all images belonging to a class corresponding to a representative vector determined to be an inappropriate image by the image identification unit 1102 from the learning images. For example, if it is determined that the representative vector W_{c} is inappropriate among the n representative vectors Wⱼ (1≤j≤n) included in the weighting matrix W, the learning image management unit 1103 excludes all images to which the class label c is assigned from the learning images.

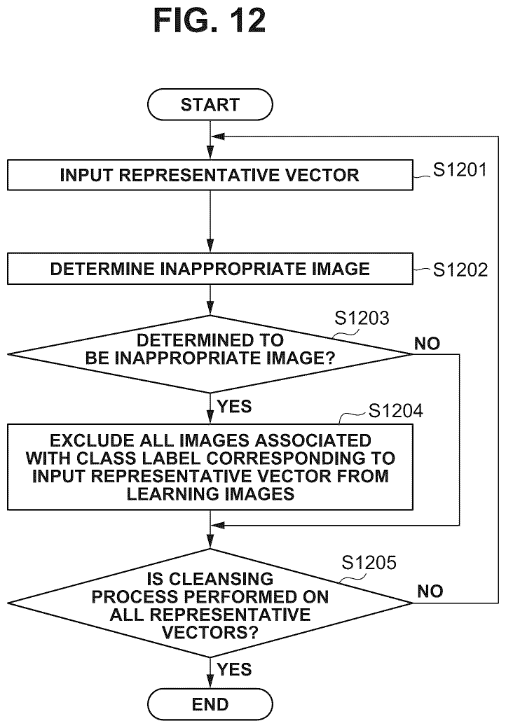

The operation of the information processing apparatus 1100 illustrated in FIG. 11 will be described with reference to FIG. 12. FIG. 12 is a flowchart illustrating an example of the processing of the information processing apparatus 1100 illustrated in FIG. 11.

In step S1201, the representative vector holding unit 1101 inputs a single representative vector that is not processed from among representative vectors held in the representative vector holding unit 1101 to the image identification unit 1102.

In step S1202, the image identification unit 1102 determines whether a learning image belonging to a class corresponding to the currently input representative vector is an inappropriate image. For example, the determination of whether the representative vector is an inappropriate image can be made similarly to the first exemplary embodiment by treating the representative vector as a single feature vector.

In step S1203, based on the determination result of the image identification unit 1102, the learning image management unit 1103 determines whether the representative vector input this time is determined to be an inappropriate image. If the learning image management unit 1103 determines that the input representative vector is determined to be an inappropriate image (YES in step S1203), the processing proceeds to step S1204. If, on the other hand, the learning image management unit 1103 determines that the input representative vector is not determined to be an inappropriate image (NO in step S1203), the processing proceeds to step S1205.

In step S1204, the learning image management unit 1103 excludes all images associated with the class label corresponding to the representative vector input this time from the learning images.

In step S1205, the learning image management unit 1103 determines whether the cleansing process is performed on all the representative vectors. If the learning image management unit 1103 determines that the cleansing process is not performed on all the representative vectors, i.e., there is a representative vector that is not processed (NO in step S1205), the processing returns to step S1201. Then, the processes of step S1201 and the subsequent steps are performed on the representative vector that is not processed. If, on the other hand, the learning image management unit 1103 determines that the cleansing process is performed on all the representative vectors (YES in step S1205), the processing illustrated in FIG. 12 (the cleansing process on the learning images) ends.

According to the present exemplary embodiment, it can be determined whether a representative vector similar to a feature vector of an incorrect identification induction image is present, and all images can be excluded that belong to a class corresponding to the representative vector determined to be an inappropriate image from learning images. Consequently, a high-quality learning image without an incorrect label can be obtained by efficiently excluding an incorrect label image or a low-quality image from all the enormous number of learning images. Learning performed using the learning images from which the inappropriate image is excluded can achieve accurate face authentication. The number of calculations of the acquisition of the similarity required by the image identification unit 1102 can also be reduced compared to the third exemplary embodiment. Specifically, in the third exemplary embodiment, calculations corresponding to the order of the number of learning images are required to acquire the similarity. In the fourth exemplary embodiment, however, the similarity can be acquired by performing calculations corresponding to the order of the number of class labels (the number of person IDs) included in the learning images.

Thus, in the present exemplary embodiment, an inappropriate image can be excluded from the learning images more efficiently than in the third exemplary embodiment.

As described above, a representative vector is a vector representing a feature vector of an image belonging to a class corresponding to the representative vector. Thus, for example, that the representative vector of the class label c is similar to a feature vector of an incorrect identification induction image means that all the images to which the class label c is assigned are similar to the incorrect identification induction image. That is, it is expected that the images associated with the class label c are a collection of very blurred images or a collection of very similar simulacrum images. Thus, it is desirable to exclude all images forming such a class from the learning images.

If there is a class in which face images of a plurality of people are allocated to a single class label, a representative vector of the class is also expected to be similar to a feature vector of an incorrect identification induction image. For example, suppose that face images of a plurality of people are mixed together in images to which a class label d is assigned. That is, suppose that the images associated with the class label d are learning images with an incorrect label. In such a case, it is predicted that learning regarding learning data for the incorrect label does not successfully proceed. This is because although the entirety of the learning is performed to classify face images of different people into different class labels, it is unreasonable to need to perform the learning to classify images of obviously different people into the same class label only in the class label d.

If a face image of a single person is allocated to a single class label, then as the learning proceeds, feature vectors of the class are expected to be approximately the same as each other, and a representative vector of the class is expected to be a vector representing these feature vectors. However, if face images of a plurality of people are allocated to a single class label (an incorrect label), it is predicted that feature vectors of the class are not approximately the same as each other, and a representative vector of the class does not represent the class, either. It is predicted that a representative vector that cannot successfully represent a class as described above is similar to a feature vector of an incorrect identification induction image (a feature vector calculated as a result of unsuccessfully extracting a feature from an incorrect identification induction image). Thus, a representative vector of an incorrect label class is expected to be determined to be an inappropriate image.

In such a case, images corresponding to the incorrect label class can be excluded from all the learning images.

### <Hardware Configuration>

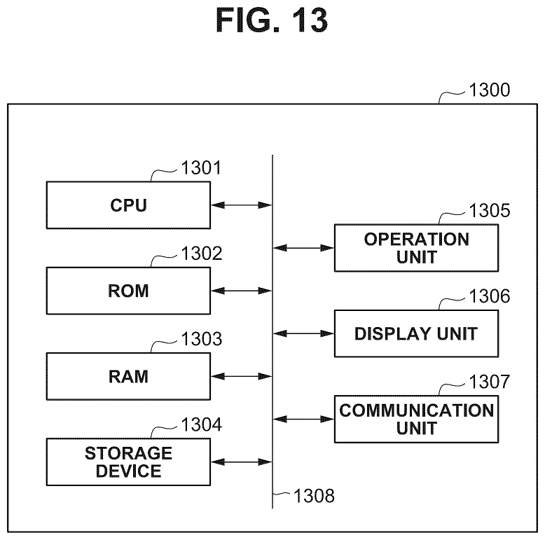

FIG. 13 is a block diagram illustrating an example of a hardware configuration of the information processing apparatus according to each of the above exemplary embodiments. An information processing apparatus 1300 includes a central processing unit (CPU) 1301, a read-only memory (ROM) 1302, a random-access memory (RAM) 1303, a storage device 1304, an operation unit 1305, a display unit 1306, a communication unit 1307, and a system bus 1308. The CPU 1301, the ROM 1302, the RAM 1303, the storage device 1304, the operation unit 1305, the display unit 1306, and the communication unit 1307 are connected together via the system bus 1308 so that these components can communicate with each other. The information processing apparatus 1300 can further include a component other than these components.

The CPU 1301 controls the entirety of the information processing apparatus 1300 using computer programs and data stored in the ROM 1302 or the RAM 1303, achieving, for example, the functions of the information processing apparatus 1300. The information processing apparatus 1300 can include one or more pieces of dedicated hardware different from the CPU 1301, and the dedicated hardware can perform at least a part of the processing of the CPU 1301. Examples of the dedicated hardware include an application-specific integrated circuit (ASIC), a field-programmable gate array (FPGA), a digital signal processor (DSP), and a graphics processing unit (GPU).

The ROM 1302 stores programs that do not need to be changed. The RAM 1303 temporarily stores programs and data supplied from the storage device 1304 and data supplied from outside via the communication unit 1307. The RAM 1303 has functions as a main memory and a work area for the CPU 1301. For example, the storage device 1304 includes a hard disk drive (HDD) or a solid-state drive (SSD) and stores various pieces of data. For example, the storage device 1304 stores various pieces of data used when the CPU 1301 performs processing according to a program and various pieces of data obtained by the CPU 1301 performing processing according to a program.

For example, the operation unit 1305 includes a keyboard, a mouse, a joystick, and a touch panel. The operation unit 1305 receives operations of the user and inputs various instructions to the CPU 1301. For example, the display unit 1306 includes a liquid crystal display or a light-emitting diode (LED) and displays the processing result of a graphical user interface (GUI) for the user to operate the information processing apparatus 1300 or the CPU 1301. The operation unit 1305 or the display unit 1306 can be present as another apparatus outside the information processing apparatus 1300. The communication unit 1307 connects the information processing apparatus 1300 to a network and controls communication between the information processing apparatus 1300 and another apparatus.

All the above exemplary embodiments merely illustrate specific examples for carrying out the present disclosure, and the technical scope of the present disclosure should not be interpreted in a limited manner based on these exemplary embodiments. That is, the present disclosure can be implemented in various ways without departing from the technical ideas or the main features of the present disclosure.

According to the present disclosure, an image inappropriate for use in an object recognition process can be identified.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-127815, which was filed on Aug. 4, 2023 and which is hereby incorporated by reference herein in its entirety.

What is claimed is:

1. An information processing apparatus comprising:
one or more memories storing instructions; and
one or more processors that, upon execution of the stored instructions, are configured to:
extract feature information from an input image;
in a case where it is determined that the extracted feature information is inappropriate for object recognition, accumulate the feature information; and
based on feature information extracted from an image as a processing target and the accumulated feature information, determine whether the image as the processing target is an inappropriate image for object recognition.

2. The information processing apparatus according to claim 1, wherein in a case where the input image is at least one of a blurred image and an incorrect detection image obtained by incorrectly detecting a target object, it is determined that the feature information regarding the input image is inappropriate for object recognition.

3. The information processing apparatus according to claim 1, wherein based on a similarity between the feature information extracted from the image as the processing target and the accumulated feature information, it is determined whether the image as the processing target is an inappropriate image.

4. The information processing apparatus according to claim 1, wherein in a case where it is determined that the feature information extracted from the input image is inappropriate, the input image is accumulated.

5. The information processing apparatus according to claim 1, wherein the one or more processors are further configured to detect a target object in the input image and extract an object area image.

6. The information processing apparatus according to claim 1,
wherein a similarity between pieces of feature information regarding two object area images is acquired,
wherein the acquired similarity is adjusted, and
wherein based on the adjusted similarity, it is determined whether target objects present in the two object area images are the same as each other.

7. The information processing apparatus according to claim 6,
wherein in a case where the adjusted similarity is higher than a threshold, it is determined that the target objects present in the two object area images are the same as each other, and
wherein in a case where, based on the feature information extracted from the image as the processing target and the accumulated feature information, it is determined that the image as the processing target is an inappropriate image for object recognition, the similarity is adjusted to be small.

8. The information processing apparatus according to claim 6, wherein in a case where it is determined that an object area image is inappropriate for object recognition, a request to register the object area image for object recognition is refused.

9. The information processing apparatus according to claim 1, wherein based on feature information extracted from each of a plurality of learning images, the plurality of learning images is managed so that an image determined to be an inappropriate image among the plurality of learning images is not used to train a learning model.

10. The information processing apparatus according to claim 9,
wherein the learning images are managed in association with class labels of the learning images,
wherein based on representative feature information representing a plurality of pieces of feature information identified based on a plurality of pieces of feature information regarding a plurality of learning images associated with a class label and the accumulated feature information, it is determined whether the representative feature information is inappropriate for object recognition, and
wherein in a case where it is determined that the representative feature information is inappropriate, the plurality of learning images is managed so that none of all the plurality of learning images associated with the class label is used to train the learning model.

11. An information processing method performed by an information processing apparatus, the information processing method comprising:
extracting feature information from an input image;
in a case where it is determined that the extracted feature information is inappropriate for object recognition, accumulating the feature information; and
based on feature information extracted from an image as a processing target and the accumulated feature information, determining whether the image as the processing target is an inappropriate image for object recognition.

12. A non-transitory computer-readable storage medium that stores computer-executable instructions that, when executed by a computer, cause the computer to:
extract feature information from an input image;
in a case where it is determined that the extracted feature information is inappropriate for object recognition, accumulate the feature information; and
based on feature information extracted from an image as a processing target and the accumulated feature information, determine whether the image as the processing target is an inappropriate image for object recognition.
